(19) United States
(12) Patent Application Publication
(10) Pub. No.: US 2026/0034889 A1
(43) Pub. Date: Feb. 5, 2026

(54) CONTROL DEVICE FOR BATTERY ELECTRIC VEHICLE

(71) Applicant: TOYOTA JIDOSHA KABUSHIKI KAISHA, Toyota-shi (JP)

(72) Inventor: Kiyoshiro UEOKA, Nagoya-shi (JP)

(73) Assignee: TOYOTA JIDOSHA KABUSHIKI KAISHA, Toyota-shi (JP)

(21) Appl. No.: 19/083,853

(22) Filed: Mar. 19, 2025

(30) Foreign Application Priority Data
Aug. 1, 2024 (JP) 2024-126007

(51) Int. Cl. B60L 3/00

(52) U.S. Cl. CPC B60L 3/0046; B60L 3/0061; B60L 2240/427

(57) ABSTRACT

A control device for a battery electric vehicle is used in a battery electric vehicle, and is configured to control a drive circuit, a voltage converter, and first and second relays. In the case where the control device controls, with the second relay controlled to turn off, the drive circuit and the first relay such that the voltage of the first capacitor changes, the control device determines that the second relay is stuck when the voltage on the connection line at a position closer to the voltage converter than the second relay changes following the voltage of the first capacitor. Sticking of the second relay can thus be determined.

### CROSS-REFERENCE TO RELATED APPLICATION

This application claims priority to Japanese Patent Application No. 2024-126007 filed on Aug. 1, 2024. The disclosure of the above-identified application, including the specification, drawings, and claims, is incorporated by reference herein in its entirety.

### BACKGROUND

### 1. Technical Field

The present disclosure relates to control devices for battery electric vehicles.

### 2. Description of Related Art

A control device for use in a battery electric vehicle including a motor, a drive circuit (inverter), an energy storage device (battery), a capacitor, a first relay (system main relay), a charge relay, and a vehicle-side connection portion has been conventionally proposed in the art (see, for example, Japanese Unexamined Patent Application Publication No. 2020-89030 (JP 2020-89030 A)). The drive circuit is configured to drive the motor. The energy storage device is connected to the drive circuit via a power line. The capacitor is attached to the power line. The first relay is attached to the power line. The charge relay is attached to a charging line connecting the power line at a position located closer to the drive circuit than the first relay and the vehicle-side connection portion. The vehicle-side connection portion is connected to an external power supply-side connection portion connected to an external power supply. The battery electric vehicle includes a direct current-to-direct current (DC-DC) converter configured to transfer electric power between the power line and an auxiliary battery after converting the voltage of the electric power. The capacitor is charged by the DC-DC converter with both the first relay and the charge relay turned off, and whether the charge relay is stuck is determined based on the voltage on the charging line between the charge relay and the vehicle-side connection portion.

### SUMMARY

In recent years, a battery electric vehicle including: a voltage converter including a second capacitor and configured to supply electric power from the charging line to a connection line after converting the voltage of the electric power; and a second relay attached to the connection line has been proposed as a battery electrode vehicle in which such a control device is used. The connection line is a line connected to the power line at a position closer to the drive circuit than the first relay. Regarding a battery electric vehicle with such a configuration, determining sticking of the second relay has been recognized as an issue to be addressed.

A control device for a battery electric vehicle according to the present disclosure can determine sticking of a second relay.

In order to achieve the above, the control device for a battery electric vehicle according to the present disclosure adopts the following measures.

In the control device for a battery electric vehicle according to the present disclosure,

The battery electric vehicle includes: a motor; a drive circuit configured to drive the motor; an energy storage device connected to the drive circuit via a power line; a first capacitor attached to the power line; a first relay attached to the power line at a position closer to the energy storage device than the first capacitor; a voltage converter including a second capacitor and configured to supply electric power from a charging line to a connection line after converting a voltage of the electric power; and a second relay attached to the connection line. The charging line is a line to which external electric power is supplied, and the connection line is connected to the power line at a position closer to the drive circuit than the first relay. The control device is used in the battery electric vehicle and is configured to control the drive circuit, the voltage converter, the first relay, and the second relay. In the case where the control device controls, with the second relay controlled to turn off, the drive circuit and the first relay such that the voltage of the first capacitor changes, the control device determines that the second relay is stuck when the voltage on the connection line at a position closer to the voltage converter than the second relay changes following the voltage of the first capacitor.

When the control device of the present disclosure controls, with the second relay controlled to turn off, the drive circuit and the first relay such that the voltage of the first capacitor changes, the voltage on the connection line at the position closer to the voltage converter than the second relay may change following the voltage of the first capacitor. In this case, it is determined that the second relay is stuck. Sticking of the second relay can thus be determined.

In the control device of the present disclosure,
in the case where the control device controls, with the first relay controlled to turn off and the second relay controlled to turn on, the drive circuit such that the first capacitor is discharged and the voltage of the first capacitor decreases, and then controls, with the first relay controlled to turn on and the second relay controlled to turn off, the drive circuit such that the first capacitor is charged and the voltage of the first capacitor increases, the control device determines that the second relay is stuck when the voltage on the connection line at the position closer to the voltage converter than the second relay increases. The control device of the present disclosure can thus determine sticking of the second relay.

In the control device of the present disclosure,
in the case where the control device controls, with the first relay and the second relay controlled to turn off, the drive circuit such that the first capacitor is discharged and the voltage of the first capacitor decreases, the control device determines that the second relay is stuck when the voltage on the connection line at the position closer to the voltage converter than the second relay decreases. The control device of the present disclosure can thus determine sticking of the second relay.

In the control device of the present disclosure,
when the control device controls the drive circuit such that the voltage of the first capacitor changes, the control device may control the drive circuit such that a d-axis current flows through the motor. With this configuration, the control device of the present disclosure can change the voltage of the first capacitor while reducing output of torque from the motor. The control device of the present disclosure can thus determine sticking of the second relay by a more appropriate method.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram schematically illustrating a configuration of a battery electric vehicle 20 in which a control device according to an embodiment of the present disclosure is mounted;

FIG. 2 is a flowchart illustrating an example of a determination routine executed by an ECU 60;

FIG. 3 is a timing chart illustrating an exemplary relation between the status of the relays, the voltage V1, and the voltage V2;

FIG. 4 is a flowchart illustrating an example of a determination routine according to another embodiment by the ECU 60; and

FIG. 5 is a timing chart illustrating an example of the relationship among the states of the relays, the voltage V1, and the voltage V2 during execution of the determination routine of FIG. 4.

### DETAILED DESCRIPTION OF EMBODIMENTS

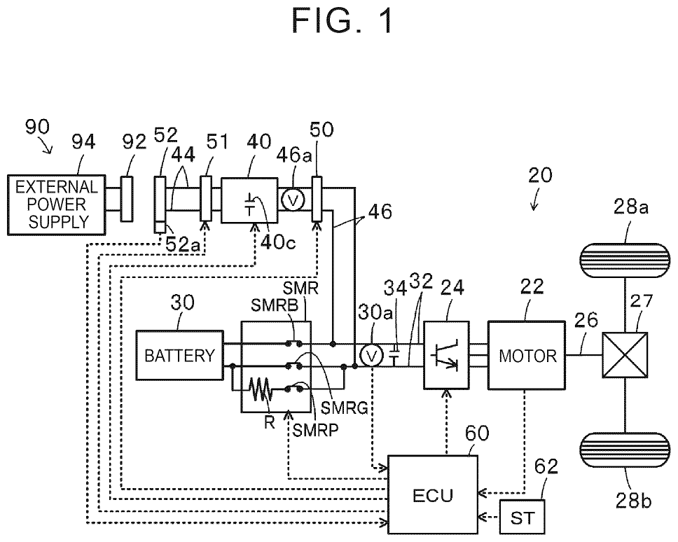

Embodiments of the present disclosure will be described with reference to the drawings. FIG. 1 is a configuration diagram schematically illustrating a configuration of a battery electric vehicle 20 in which a control device according to an embodiment of the present disclosure is mounted. As illustrated, battery electric vehicle 20 of the embodiment includes a traction motor 22, an inverter (drive circuit) 24, and a battery (energy storage device) 30. Battery electric vehicle 20 of the embodiment further includes a smoothing capacitor (first capacitor) 34, a system main relay (first relay) SMR, a booster (voltage converter) 40, a cutoff relay (second relay) 50, a charge relay 51, and an electronic control unit (control device; hereinafter referred to as “ECU”) 60. The control device for battery electric vehicle of the embodiment mainly corresponds to an ECU 60.

The motor 22 is configured as a synchronous generator motor, and includes a rotor in which a permanent magnet is embedded, and a stator in which a three-phase coil is wound. The rotor of the motor 22 is connected to a drive shaft 26 connected to drive wheels 28a, 28b via a differential gear 27.

The inverter 24 is connected to the motor 22, and is also connected to the power line 32. The inverter 24 is configured as a well-known inverter circuit including six transistors and six diodes. The inverter 24 is controlled by the ECU 60.

The battery 30 is configured as a battery having a plurality of lithium-ion secondary batteries, and is connected to the power line 32.

The smoothing capacitor 34 is attached to the power line 32.

The system main relay SMR is attached to the power line 32. The system main relay SMR includes a positive-side relay SMRB provided on the positive bus of the power line 32, a negative-side relay SMRG provided on the negative bus of the power line 32, and a pre-charge circuit. In the pre-charge circuit, the pre-charge resistor R and the pre-charge relay SMRP are connected in series so as to bypass the negative-side relay SMRG. The system main relay SMR is controlled by the ECU 60.

The booster 40 includes a capacitor (second capacitor) 40c, boosts the electric power supplied to the charging line 44 from the vehicle-side connection portion 52, and supplies the boosted electric power to the connection line 46. The vehicle-side connection portion 52 is configured to be connectable to a facility-side connection portion 92 connected to an external power source 94 of the charging facility 90 installed in a home, a charging station, or the like. The connection line 46 is connected to the inverter 24 from the system main relay SMR of the power line 32. The booster 40 is controlled by the ECU 60.

The cutoff relay 50 is attached to the connection line 46. The charge relay 51 is attached to the charging line 44. The cutoff relay 50 and the charge relay 51 are controlled by the ECU 60.

The ECU 60 includes a microcomputer including a CPU etc. Signals from various sensors are input to the ECU 60 through the input ports. Examples of the signals that are input to the ECU 60 include a rotational position of the rotor of the motor 22 from a rotational position sensor (for example, a resolver) that detects the rotational position of the rotor of the motor 22, and a voltage V1 from a voltage sensor 30a that detects the voltage of the smoothing capacitor 34. Other examples of the signals that are input to the ECU 60 include a voltage V2 from a voltage sensor 46a for detecting a voltage on the connection line 46 at a position closer to the booster 40 than the cutoff relay 50 (voltage on the connection line at a position closer to the voltage converter than the second relay), a connection signal from a connection detection sensor 52a for detecting connection between the vehicle-side connection portion 52 and the facility-side connection portion 92, and a start signal from the start switch 62. The ECU 60 also functions as a drive control device for battery electric vehicle 20, and therefore, a detection value from a sensor (for example, an accelerator pedal position sensor or a vehicle speed sensor that detects a depression amount of an accelerator pedal) required for drive control of battery electric vehicle 20 is also input to the ECU 60. From the ECU 60, various control signals such as a control signal to a plurality of switching elements of the inverter 24, a drive signal to the system main relay SMR, a control signal to the booster 40, a drive signal to the cutoff relay 50, and a drive signal to the charge relay 51 are output via an output port. In the ECU 60, when the vehicle-side connection portion 52 and the facility-side connection portion 92 of the charging facility 90 are connected, the signal line of the facility-side connection portion 92 of the charging facility 90 and the signal line of the vehicle-side connection portion 52 are connected, and various signals can be exchanged with the charging facility 90.

In battery electric vehicle 20 equipped with the control device according to the embodiment configured as described above, when the start switch 62 is turned on by the user, the ECU 60 turns on the system main relay SMR to perform the ready-on (system-on). In the connecting process when the system main relay SMR is turned on, the positive-side relay SMRB and the pre-charge relay SMRP are turned on to pre-charge (charge) the smoothing capacitor 34, and then the negative-side relay SMRG is turned on and the pre-charge relay SMRP is turned off. Note that the pre-charge of the smoothing capacitor 34 is performed by turning on the positive-side relay SMRB and the pre-charge relay SMRP to form a closed circuit including the positive electrode of the battery 30, the positive-side relay SMRB, smoothing capacitor 34, and the pre-charge relay SMRP, the pre-charge resistor R, the negative electrode of the battery 30. After that, when the start switch 62 is turned off, the system main relay SMR is turned off (positive-side relay SMRB and the negative-side relay SMRG and the pre-charge relay SMRP are turned off) and ready-off (the system is turned off).

While the vehicle is stopped in the ready-off state, it is sometimes detected that the vehicle-side connection portion 52 and the facility-side connection portion 92 of the charging facility 90 are connected by the connection detection sensor 52a. At that time, the ECU 60 turns on the positive-side relay SMRB and the negative-side relay SMRG of the system main relay SMR, the cutoff relay 50, and the charge relay 51. Then, the ECU 60 controls the booster 40 such that the voltage V2 on the connection line 46 becomes higher than the voltage of the battery 30, and performs external charging that is charging of the battery 30 using the direct current power from the charging facility 90.

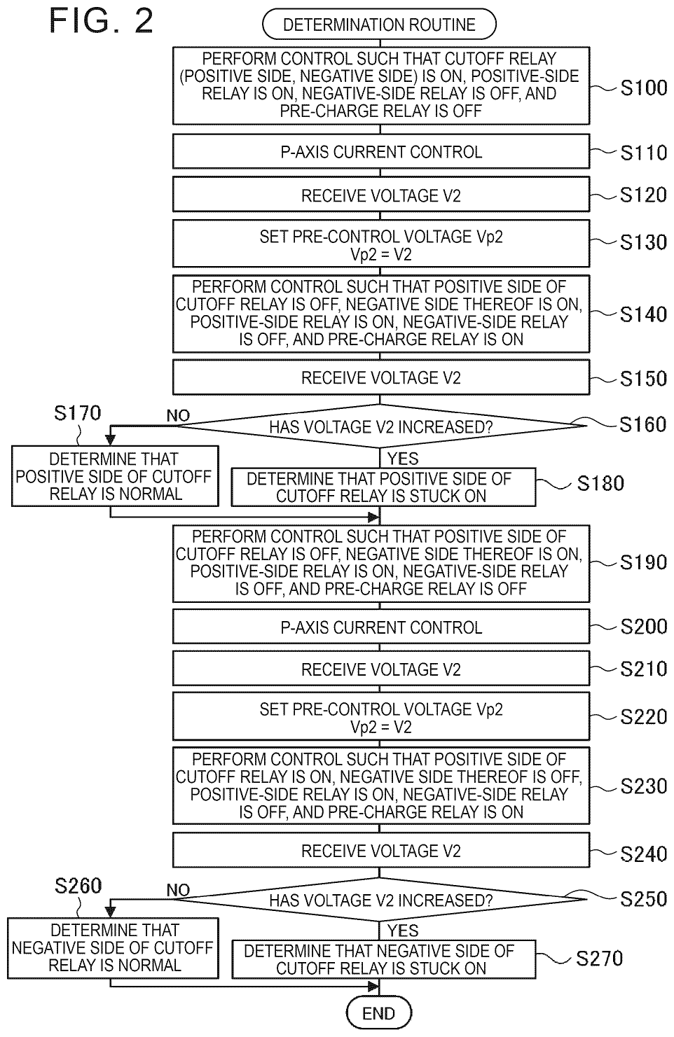

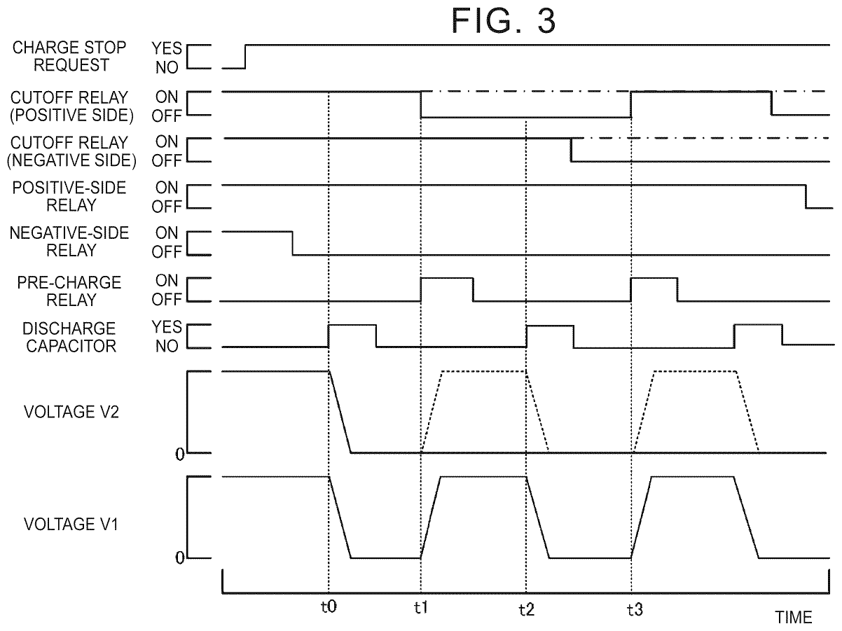

Next, the operation of the battery electric vehicle 20 equipped with the control device of the embodiment with this configuration, in particular, the operation that is performed when determining whether the cutoff relay 50 is stuck on when ending the external charging will be described. FIG. 2 is a flowchart illustrating an example of the determination routine that is executed by the ECU 60. This routine is executed when the charge stopping signal is transmitted to the charging facility 90 by the ECU 60 when the state of charge of the battery 30 becomes equal to or more than a predetermined value during external charging, and the charge relay 51 is turned off. During execution of the determination routine of FIG. 2, the charge relay 51 is off. When the charging stop signal is received, the charging facility 90 stops the supply of electric power from the external power source 94 to the facility-side connection portion 92. FIG. 3 is a timing chart illustrating an exemplary relation between the status of the relays, the voltage V1, and the voltage V2.

When this routine is executed, the CPU, not shown, of the ECU 60 controls such that both the positive side and the negative side of the cutoff relay 50 are turned on, the positive-side relay SMRB is turned on, the negative-side relay SMRG is turned off, and the pre-charge relay SMRP is turned off. As described above, the CPU, not shown, of the ECU 60 controls the cutoff relay 50, the positive-side relay SMRB, the negative-side relay SMRG, and the pre-charge relay SMRP (S100). Then, the ECU 60 executes P-axis current control for controlling the inverter 24 such that the d-axis current flows through the motor 22 (S110). Accordingly, the capacitor 40c of the smoothing capacitor 34 and the booster 40 can be discharged without outputting the torque from the motor 22 (while suppressing the output of the torque from the motor 22). Then, the ECU 60 receives a voltage V2 from the voltage sensor 30a (S120). Further, the ECU 60 sets the received voltage V2 to the pre-control voltage Vp2 (S130). In S110, since the ECU 60 discharges the smoothing capacitor 34 and the capacitor 40c, as shown in FIG. 3, the voltage V1 of the smoothing capacitor 34 and the voltage V2 on the connection line 46 at a position closer to the booster 40 than the cutoff relay 50 decrease to 0 (time t0). Thus, the pre-control voltage Vp2 is set to the value of zero.

Subsequently, the positive side of the cutoff relay 50 is turned off, the negative side of the cutoff relay 50 is turned on, the positive-side relay SMRB is turned on, the negative-side relay SMRG is turned off, and the pre-charge relay SMRP is turned on. As described above, the cutoff relay 50, the positive-side relay SMRB, the negative-side relay SMRG, and the pre-charge relay SMRP are controlled (S140). Then, the ECU 60 receives a voltage V2 from the voltage sensor 30a (S150). The ECU 60 determines whether the received voltage V2 has increased from the pre-control voltage Vp2 (S160). Since the ECU 60 turns on the positive-side relay SMRB and the pre-charge relay SMRP in S140, the electric power from the battery 30 is supplied to the smoothing capacitor 34 via the power line 32, and the smoothing capacitor 34 is pre-charged (charged). At this time, as shown in FIG. 3, the voltage V1 of the smoothing capacitor 34 increases from 0 (time t1). Since the ECU 60 controls such that the positive side of the cutoff relay 50 is turned off and the negative side is turned on, when the positive side of the cutoff relay 50 is normal, the connection line 46 is shut off and no current flows from the connection line 46 to the booster 40. Therefore, the capacitor 40c is not charged, and as shown by a continuous line in FIG. 3, the voltage V2 on the connection line 46 at the position closer to the booster 40 than the cutoff relay 50 does not change from 0. When an abnormality occurs in which the positive side of the cutoff relay 50 is stuck on, the positive side of the cutoff relay 50 is continuously turned on without being turned off, as indicated by a long dashed short dashed line in FIG. 3. At this time, since the negative side of the cutoff relay 50 is on, a current flows from the connection line 46 to the booster 40 without interrupting the connection line 46, the capacitor 40c is charged, as shown by a dashed line in FIG. 3, the voltage V2 increases following the voltage V1. By checking the voltage V2 in this way, it is possible to determine whether an abnormality has occurred in which the positive side of the cutoff relay 50 is stuck on. Therefore, S160 is a process of determining whether an abnormality has occurred in which the positive side of the cutoff relay 50 is stuck on.

When the voltage V2 has not increased from the pre-control voltage Vp2 at S160, the ECU 60 determines that the voltage V2 is not following the voltage V1, and determines that the positive side of the cutoff relay 50 is normal (S170). When the voltage V2 has increased from the pre-control voltage Vp2 in S160, the ECU 60 determines that the voltage V2 is following the voltage V1, and determines that the positive side of the cutoff relay 50 is stuck on (S180). Sticking of the positive side of the cutoff relay 50 at on position can thus be determined. Since whether the positive side of the cutoff relay 50 is stuck on can be determined in S100 to S180 without outputting torque from the motor 22, sticking of the positive side of the cutoff relay 50 at on position can be determined by a more appropriate method.

Subsequently, in the same process as in S100, the ECU 60 performs control such that both the positive side and the negative side of the cutoff relay 50 are turned on, the positive-side relay SMRB is turned on, the negative-side relay SMRG is turned off, and the pre-charge relay SMRP is turned off. As described above, the ECU 60 controls the cutoff relay 50, the positive-side relay SMRB, the negative-side relay SMRG, and the pre-charge relay SMRP (S190). Then, the ECU 60 executes P-axis current control in the same process as S110 (S200). Accordingly, the capacitor 40c of the smoothing capacitor 34 and the booster 40 are discharged without outputting the torque from the motor 22. Further, the ECU 60 receives V2 in the same process as S120 (S210). In addition, the ECU 60 sets the received voltage V2 to the pre-control voltage Vp2 by the same process as S130 (S220). Since the capacitor 40c of the booster 40 is discharged by S200, the pre-control voltage Vp2 is set to the value of zero.

Subsequently, the positive side of the cutoff relay 50 is turned on, the negative side of the cutoff relay 50 is turned off, the positive-side relay SMRB is turned on, the negative-side relay SMRG is turned off, and the pre-charge relay SMRP is turned on. As described above, the cutoff relay 50, the positive-side relay SMRB, the negative-side relay SMRG, and the pre-charge relay SMRP are controlled (S230). Then, the ECU 60 receives a voltage V2 from the voltage sensor 30a (S240). The ECU 60 determines whether the received voltage V2 has increased from the pre-control voltage Vp2 (S250). Since the ECU 60 turns on the positive-side relay SMRB and the pre-charge relay SMRP in S230, the electric power from the battery 30 is supplied to the smoothing capacitor 34 via the power line 32, and the smoothing capacitor 34 is pre-charged (charged). At this time, as shown in FIG. 3, the voltage V1 of the power line 32 increases from 0 (time t3). Since the ECU 60 controls such that the positive side of the cutoff relay 50 is turned on and the negative side is turned off, when the negative side of the cutoff relay 50 is normal, the connection line 46 is shut off and no current flows from the connection line 46 to the booster 40. Therefore, the capacitor 40c is not charged, and the voltage V2 does not change from 0, as indicated by a continuous line in FIG. 3. When an abnormality occurs in which the negative side of the cutoff relay 50 is stuck on, the negative side of the cutoff relay 50 continues to be on and will not turn off, as indicated by a long dashed short dashed line in FIG. 3. At this time, a current flows from the connection line 46 to the booster 40 without interrupting the connection line 46, the capacitor 40c is charged, and the voltage V2 increases following the voltage V1, as shown by a dashed line in FIG. 3. As described above, whether an abnormality has occurred in which the negative side of the cutoff relay 50 is stuck on can be determined by checking the voltage V2. Therefore, S250 is a process of determining whether an abnormality has occurred in which the positive side of the cutoff relay 50 is stuck on.

When the voltage V2 has not increased from the pre-control voltage Vp2 in S250, the ECU 60 determines that the voltage V2 is not following the voltage V1 and determines that the negative side of the cutoff relay 50 is normal (S260), and ends the routine. When the voltage V2 has increased from the pre-control voltage Vp2 in S250, the ECU 60 determines that the voltage V2 is following the voltage V1 and determines that the negative side of the cutoff relay 50 is stuck on (S270), and ends the routine. Sticking of the negative side of the cutoff relay 50 at on position can thus be determined. Since whether the negative side of the cutoff relay 50 is stuck on can be determined in S190 to S270 without outputting torque from the motor 22, sticking of the negative side of the cutoff relay 50 at on position can be determined by a more appropriate method.

According to the battery electric vehicle 20 equipped with the control device of the present embodiment described above, with the cutoff relay 50 controlled to turn off, the inverter 24 and the system main relay SMR may be controlled such that the voltage V1 of the smoothing capacitor 34 changes. When the voltage V2 on the connection line 46 at the position closer to the booster 40 than the cutoff relay 50 changes following the voltage V1, it is determined that the cutoff relay 50 is stuck. Sticking of the cutoff relay 50 can thus be determined.

In the battery electric vehicle 20 equipped with the control device of the present embodiment, with the system main relay SMR and the cutoff relay 50 controlled such that the system main relay SMR turns off and the cutoff relay 50 turns on, the inverter 24 is controlled such that the smoothing capacitor 34 is discharged and the voltage V1 of the smoothing capacitor 34 decreases. Thereafter, with the system main relay SMR and the cutoff relay 50 controlled such that the system main relay SMR turns off and the cutoff relay 50 turns off, the inverter 24 is controlled such that the smoothing capacitor 34 is pre-charged (charged) and the voltage V1 of the smoothing capacitor 34 increases. In this case, when the voltage V2 on the connection line 46 at the position closer to the booster 40 than the cutoff relay 50 increases, it is determined that the cutoff relay 50 is stuck. Sticking of the cutoff relay 50 can thus be determined.

Further, in battery electric vehicle 20 equipped with the control device of the present embodiment, when the inverter 24 is controlled such that the voltage V1 of the smoothing capacitor 34 changes, the inverter 24 is controlled such that the d-axis current flows through the motor 22. Sticking of the cutoff relay 50 can thus be determined by a more appropriate method.

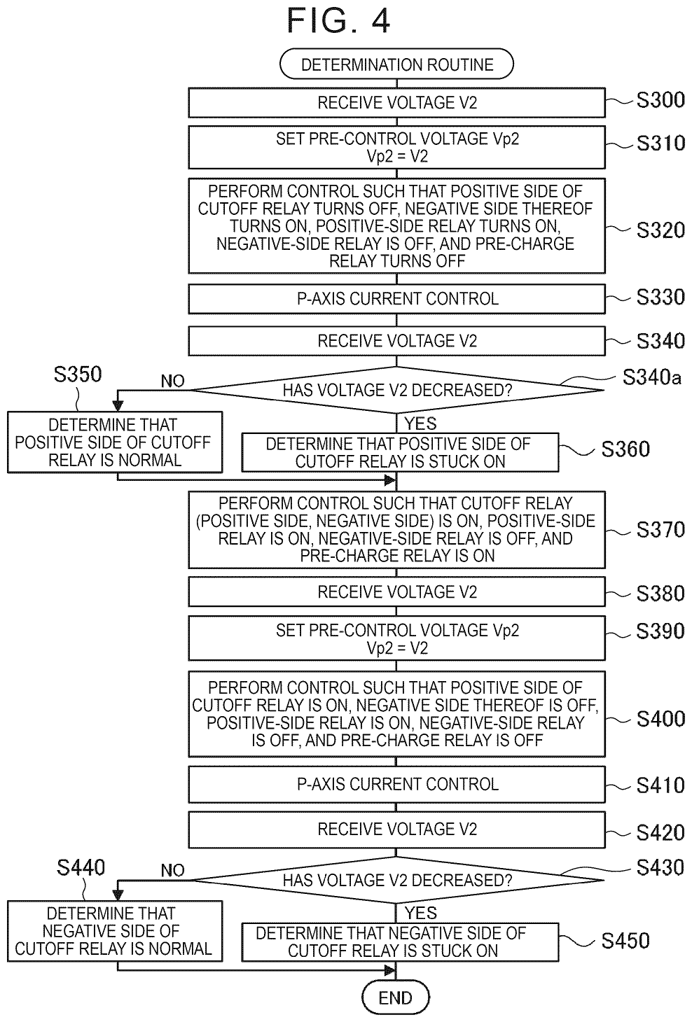

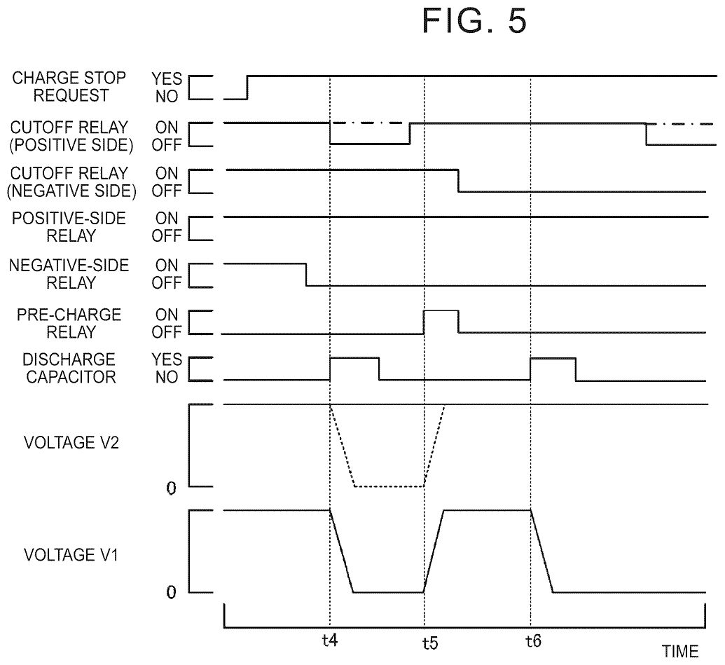

In the above embodiment, the ECU 60 executes the determination routine illustrated in FIG. 2. However, a determination routine of another embodiment illustrated in FIG. 4 may be executed instead of the determination routine illustrated in FIG. 2. FIG. 4 is a flowchart illustrating an example of the determination routine that is executed by the ECU 60 according to another embodiment. FIG. 5 is a timing chart illustrating an example of the relationship among the states of the relays, the voltage V1, and the voltage V2 during execution of the determination routine of FIG. 4.

When the determination routine of FIG. 4 is executed, the ECU 60 receives V2 as in S120 (S300). Next, the ECU 60 sets the pre-control voltage Vp2 as in S130 (S310). Immediately after this routine is started, the smoothing capacitor 34 and the capacitor 40c are charged together. Therefore, the pre-control voltage Vp2 has a voltage equal to the voltage of the battery 30. When the pre-control voltage Vp2 is set, the ECU 60 performs control such that the positive side of the cutoff relay 50 is turned off, the negative side is turned on, the positive-side relay SMRB is turned on, the negative-side relay SMRG is turned off, and the pre-charge relay SMRP is turned off. As described above, the ECU 60 controls the cutoff relay 50, the positive-side relay SMRB, the negative-side relay SMRG, and the pre-charge relay SMRP (S320). Further, the ECU 60 performs P-axis current control (S330), similar to S110. Then, the ECU 60 receives the voltage V2 in the same manner as S120 (S340). When the ECU 60 receives the voltage V2, it determines whether the received voltage V2 has decreased from the pre-control voltage Vp2 (S340a). When S320, 330 is executed, the smoothing capacitor 34 is discharged. Therefore, the voltage V1 decreases (time t4). At this time, when the positive side of the cutoff relay 50 is normal, the connection line 46 is interrupted, and no current flows from the connection line 46 to the booster 40. Therefore, since the capacitor 40c is not discharged, the voltage V2 is maintained at a voltage equal to the voltage of the battery 30, as shown by a continuous line in FIG. 5. When such an abnormality occurs in which the positive side of the cutoff relay 50 is stuck on, the positive side of the cutoff relay 50 continues to be ON and will not turn off (time t4), as indicated by a long dashed short dashed line in FIG. 5. At this time, since the negative side of the cutoff relay 50 is on, current flows from the connection line 46 to the booster 40 without interrupting the connection line 46, and the capacitor 40c is discharged. As indicated by a dashed line in FIG. 5, the voltage V2 decreases following the voltage V1 (time t4). By checking the voltage V2 in this way, it is possible to determine whether an abnormality has occurred in which the positive side of the cutoff relay 50 is stuck on. Therefore, S340a is a process of determining whether an abnormality has occurred in which the positive side of the cutoff relay 50 is stuck on.

When the voltage V2 has not decreased from the pre-control voltage Vp2 in S340a, the ECU 60 determines that the voltage V2 is not following the voltage V1, and determines that the positive side of the cutoff relay 50 is normal (S350). When the voltage V2 has decreased from the pre-control voltage Vp2 at S340a, the ECU 60 determines that the voltage V2 is following the voltage V1, and determines that the positive side of the cutoff relay 50 is stuck on (S360). Sticking of the positive side of the cutoff relay 50 at on position can thus be determined. Since whether the positive side of the cutoff relay 50 is stuck on is determined in S300 to S360 without outputting torque from the motor 22, whether sticking of the positive side of the cutoff relay 50 at on position can be determined by a more appropriate method.

Subsequently, the ECU 60 is controlled so as to be turned on together with the positive side and the negative side of the cutoff relay 50, the positive-side relay SMRB is turned on, the negative-side relay SMRG is turned off, and the pre-charge relay SMRP is turned on. As described above, the ECU 60 controls the cutoff relay 50, the positive-side relay SMRB, the negative-side relay SMRG, and the pre-charge relay SMRP (S370). Since the ECU 60 turns on the positive-side relay SMRB and the pre-charge relay SMRP in S370, the electric power from the battery 30 is supplied to the smoothing capacitor 34 via the power line 32, and the smoothing capacitor 34 is pre-charged (charged). At this time, as shown in FIG. 5, the voltage V1 of the power line 32 increases from 0 (time t5). As shown by a continuous line in FIG. 5, the voltage V2 is maintained at a voltage equal to the voltage of the battery 30 when the positive side of the cutoff relay 50 is normal. As shown by a long dashed short dashed line in FIG. 5, since the connection line 46 is not interrupted when the positive side of the cutoff relay 50 is stuck on, current flows from the connection line 46 to the booster 40 and the capacitor 40c is charged in the voltage V2. As indicated by a dashed line in FIG. 5, the voltage V2 increases following the voltage V1.

The ECU 60 then receives the voltage V2 as in S120 (S380). Further, the pre-control voltage Vp2 is set to the received voltage V2 (S390). Therefore, the pre-control voltage Vp2 has a voltage equal to the voltage of the battery 30. When the pre-control voltage Vp2 is set, the ECU 60 performs control such that the positive side of the cutoff relay 50 is turned on, the negative side is turned off, the positive-side relay SMRB is turned on, the negative-side relay SMRG is turned off, and the pre-charge relay SMRP is turned off. As described above, the ECU 60 controls the cutoff relay 50, the positive-side relay SMRB, the negative-side relay SMRG, and the pre-charge relay SMRP (S400). Further, the ECU 60 performs P-axis current control (S410), similar to S110. Then, the ECU 60 receives the voltage V2 as in S120 (S420). The ECU 60 determines whether the received voltage V2 has decreased from the pre-control voltage Vp2 (S430). When S400, S410 is executed, the smoothing capacitor 34 is discharged. When the negative side of the cutoff relay 50 is normal, the connection line 46 is interrupted, and no current flows from the connection line 46 to the booster 40. Since the capacitor 40c is not discharged, the voltage V2 is maintained at the voltage of the battery 30 (temporal t6), as shown by a continuous line in FIG. 5. When an abnormality occurs in which the negative side of the cutoff relay 50 is stuck on, the negative side of the cutoff relay 50 is continuously turned on without being turned off. When the negative side of the cutoff relay 50 is turned on, the connection line 46 is not interrupted, and a current flows from the connection line 46 to the booster 40, the capacitor 40c is discharged, and the voltage V2 decreases following the voltage V1. By checking the voltage V2 in this way, it is possible to determine whether an abnormality has occurred in which the negative side of the cutoff relay 50 is stuck on. Therefore, S430 is a process of determining whether an abnormality has occurred in which the positive side of the cutoff relay 50 is stuck on.

When the voltage V2 has not decreased from the pre-control voltage Vp2 in S430, the ECU 60 determines that the voltage V2 is not following the voltage V1 and determines that the negative side of the cutoff relay 50 is normal (S440), and ends the routine. When the voltage V2 has decreased from the pre-control voltage Vp2 in S430, the ECU 60 determines that the voltage V2 is following the voltage V1 and determines that the negative side of the cutoff relay 50 is stuck on (S450), and ends the routine. Sticking of the negative side of the cutoff relay 50 at on position can thus be determined. Since whether the negative side of the cutoff relay 50 is stuck on is determined in S370 to S450 without outputting torque from the motor 22, sticking of the negative side of the cutoff relay 50 at on position can be determined by a more appropriate method.

In the above embodiment, the inverter 24 is controlled such that the voltage V1 of the smoothing capacitor 34 changes by executing the P-axis current control in S110, S200. However, as a method of controlling the inverter 24 such that the voltage V1 of the smoothing capacitor 34 changes, there is a case where some torque is allowed to be output from the motor 22. At that time, the inverter 24 may be controlled to be driven with some torque output from the motor 22.

In the above embodiment, in S140, S230, the smoothing capacitor 34 is pre-charged (charged) by turning on the positive-side relay SMRB, turning off the negative-side relay SMRG, and turning on the pre-charge relay SMRP. However, when battery electric vehicle 20 is not equipped with a pre-charge circuit, i.e., it may not be equipped with a pre-charge relay SMRP. At this time, the negative-side relay SMRG may be turned on instead of the pre-charge relay SMRP.

In the above embodiment, the battery electric vehicle 20 includes a booster 40. However, in place of the booster 40, any type of booster may be used as long as it supplies electric power from the charging line 44, namely the charging line that includes a capacitor and to which external electric power is supplied, to the connection line 46 after converting the voltage of the electric power. For example, instead of the booster 40, an operation of boosting the power supplied to the charging line 44 and supplying the power to the connection line 46 and an operation of boosting the power supplied to the connection line 46 and supplying the power to the charging line 44 are possible.

In the above embodiment, the battery electric vehicle 20 is configured to include the motor 22 for traveling. However, instead of this, for example, a configuration of a hybrid electric vehicle including a motor and an engine, or a configuration of a fuel cell electric vehicle including a motor and a fuel cell may be employed.

In the above embodiment, the battery 30 is used as an energy storage device. However, a capacitor etc. may be used instead.

The correspondence between the main elements of the embodiments and the main elements of the disclosure described in the column of the means for solving the problem will be described. In the embodiment, the motor 22 corresponds to the “motor,” the inverter 24 corresponds to the “inverter,” and the battery 30 corresponds to the “energy storage device.” The smoothing capacitor 34 corresponds to the “first capacitor,” the system main relay SMR corresponds to the “first relay,” the booster 40 corresponds to the “voltage converter,” and the cutoff relay 50 corresponds to the “second relay.” The ECU 60 corresponds to the “control device.”

The correspondence between the main elements of the embodiment and the main elements of the disclosure described in the section of the means for solving the problem is an example for specifically explaining the embodiment of the disclosure described in the section of the means for solving the problem. Therefore, the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to a manufacturing industry of a control device for a battery electric vehicle, and the like.

What is claimed is:

1. A control device for a battery electric vehicle, wherein:
the battery electric vehicle includes a motor, a drive circuit configured to drive the motor, an energy storage device connected to the drive circuit via a power line, a first capacitor attached to the power line, a first relay attached to the power line at a position closer to the energy storage device than the first capacitor, a voltage converter including a second capacitor and configured to supply electric power from a charging line to a connection line after converting a voltage of the electric power, and a second relay attached to the connection line, the charging line being a line to which external electric power is supplied, and the connection line being connected to the power line at a position closer to the drive circuit than the first relay;
the control device is used in the battery electric vehicle and is configured to control the drive circuit, the voltage converter, the first relay, and the second relay; and
in a case where the control device controls, with the second relay controlled to turn off, the drive circuit and the first relay such that a voltage of the first capacitor changes, the control device determines that the second relay is stuck when a voltage on the connection line at a position closer to the voltage converter than the second relay changes following the voltage of the first capacitor.

2. The control device according to claim 1, wherein in a case where the control device controls, with the first relay controlled to turn off and the second relay controlled to turn on, the drive circuit such that the first capacitor is discharged and the voltage of the first capacitor decreases, and then controls, with the first relay controlled to turn on and the second relay controlled to turn off, the drive circuit such that the first capacitor is charged and the voltage of the first capacitor increases, the control device determines that the second relay is stuck when the voltage on the connection line at the position closer to the voltage converter than the second relay increases.

3. The control device according to claim 1, wherein in a case where the control device controls, with the first relay and the second relay controlled to turn off, the drive circuit such that the first capacitor is discharged and the voltage of the first capacitor decreases, the control device determines that the second relay is stuck when the voltage on the connection line at the position closer to the voltage converter than the second relay decreases.

4. The control device according to claim 1, wherein when the control device controls the drive circuit such that the voltage of the first capacitor changes, the control device controls the drive circuit such that a d-axis current flows through the motor.
